(19) United States
(12) Patent Application Publication
(10) Pub. No.: US 2009/0290004 A1
(43) Pub. Date: Nov. 26, 2009

(54) INK RESERVOIR

(75) Inventors: Takashi Fukushima, Yokohama-shi (JP); Toshihiko Ujita, Yokohama-shi (JP); Akihiko Shimomura, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/470,410

(22) Filed: May 21, 2009

(30) Foreign Application Priority Data
May 23, 2008 (JP) 2008-135686

(51) Int. Cl. B41J 2/175

(52) U.S. Cl. 347/86

(57) ABSTRACT

An ink reservoir capable of retaining ink includes a case having a polypropylene, and a fibrous absorber contained in the case, the fibrous absorber having an aggregate of fiber with a double-layer structure including a core and a sheath, the sheath being fused at intersections of fiber loops. The core has a polypropylene homopolymer having a melting point of 140° C. or more, and the sheath has an ethylene-propylene random copolymer having a melting point of less than 140° C. and a melt mass-flow rate of 7 g/10 min or more as measured at 230° C. and a load of 2.16 kg according to JIS K 7210.

### BACKGROUND OF THE INVENTION

1. Field of the Invention

The present invention relates to an ink reservoir containing a fibrous absorber comprising a fiber material and retaining an ink.

2. Description of the Related Art

It is known that inkjet recording apparatuses use the following ink reservoirs. One is an ink jet cartridge including an inkjet recording head and an ink reservoir containing an ink to be supplied. The inkjet recording head and the ink reservoir are integrated in one body. Another is an ink reservoir 1 which is independent of the inkjet recording head and removably connected to the inkjet recording head through an inlet tube. The ink reservoir 1, which is just an example, includes an absorber holder holding an absorber 2 and an ink chamber directly containing an ink. The absorber holder and the ink chamber are disposed adjacent to each other.

Either ink reservoir has a structure acting as a negative pressure source for the inkjet recording head inside. A well-known structure contains an absorber for retaining ink. The negative pressure produced by the absorber is appropriately adjusted so that the ink does not leak from the recording head and can be supplied adequately.

The absorber may be made of a fiber material satisfying specific requirements, as disclosed in Japanese Patent Laid-Open Nos. 9-123477, 7-148938 (U.S. Pat. No. 5,784,088), 2000-79700 (U.S. Pat. No. 6,485,136) or 2004-174920 (U.S. Pat. No. 7,014,302). The fiber of such a fiber material is aggregated and fused at intersections of the fiber loops. Thus, the resulting absorber can hold a negative pressure sufficient to be used in an ink reservoir and has a sufficient strength as a fibrous absorber. Such a fiber material may have a structure disclosed in Japanese Patent Laid-Open No. 11-061637 (U.S. Pat. No. 6,815,381), and may have a double-layer structure including a core and a sheath. The fiber is aggregated and the sheath is fused at intersections of the fiber loops in the aggregate. The fiber material of the fibrous absorber includes a polypropylene core and a sheath made of polyethylene having a lower melting point than the polypropylene of the core.

Olefin resins, such as polypropylene and polyethylene, contain a neutralizer to eliminate the influence of the residue of the Ziegler-Natta catalyst used for polymerization. A metal salt of fatty acids, such as calcium stearate, is generally used as the neutralizer. Calcium stearate is easily dissolved in ink. Accordingly, calcium stearate leached from the absorber can precipitate according to the environmental conditions, and can, in some instances, be deposited on the ink flow filter, ink nozzle or the like of the inkjet printer, thus negatively affecting the printing operation. A hydrotalcite compound may be used as a neutralizer not easily leached. The hydrotalcite compound however slightly leaches Al. The Al or Al compounds can also be deposited on the nozzle. Hydrotalcite compounds do not particularly affect nozzles having the currently employed structures. However, if a finer or more complicated nozzle structure is proposed in the future, particularly a nozzle having a smaller diameter, even a very small amount of deposit can negatively affect the printing operation. It is therefore desirable for future applications that the use of even a hydrotalcite compound is avoided if possible.

On the other hand, it is desired that plastic products be environmentally friendly. For example, for waste plastics that can be recycled through an appropriate process, attempts are being made to collect and recycle them.

However, if a composite plastic is collected for recycling, for example, the plastic typically cannot be recycled into a material having desired properties because of the different properties of the materials in the plastic. Accordingly, the materials are typically separated. However, separation is not easy and can be a bottleneck of recycling.

Also, the ink reservoir typically cannot be made of a plastic product that is a single material, even though such material could possibly facilitate recycling, because the components of the ink reservoir have their respective functions and thus their respective properties. It is therefore difficult to produce a suitable ink reservoir from a single material. Thus, in general, the body of the ink reservoir is made of a propylene resin, and a fibrous absorber is made of polypropylene and polyethylene having different melting points so that fibers of the absorber can be fused together, as disclosed in Japanese Patent Laid-Open No. 11-061637 (U.S. Pat. No. 6,815,381).

### SUMMARY OF THE INVENTION

According to an aspect of the invention, an ink reservoir capable of retaining ink is provided which includes a case having a polypropylene, and a fibrous absorber contained in the case, the fibrous absorber having an aggregate of fiber with a double-layer structure including a core and a sheath, the sheath being fused at intersections of fiber loops. The core has a polypropylene homopolymer having a melting point of 140° C. or more, and the sheath has an ethylene-propylene random copolymer having a melting point of less than 140° C. and a melt mass-flow rate of 7 g/10 min or more as measured at 230° C. and a load of 2.16 kg according to JIS K 7210.

Further features of the present invention will become apparent from the following description of exemplary embodiments with reference to the attached drawings.

### BRIEF DESCRIPTION OF THE DRAWINGS

FIG. 1 is a conceptual representation of the relationship between the forming temperature required to fuse fiber and the melt viscosity of the sheath.

FIG. 2 is a scanning electron micrograph of a fused fiber.

FIG. 3 is a scanning electron micrograph of an unfused fiber.

FIG. 4 is a schematic front sectional view of an ink reservoir according to an embodiment of the invention.

FIG. 5 is a sectional view of an embodiment of a fiber having a core/sheath structure.

### DESCRIPTION OF THE EMBODIMENTS

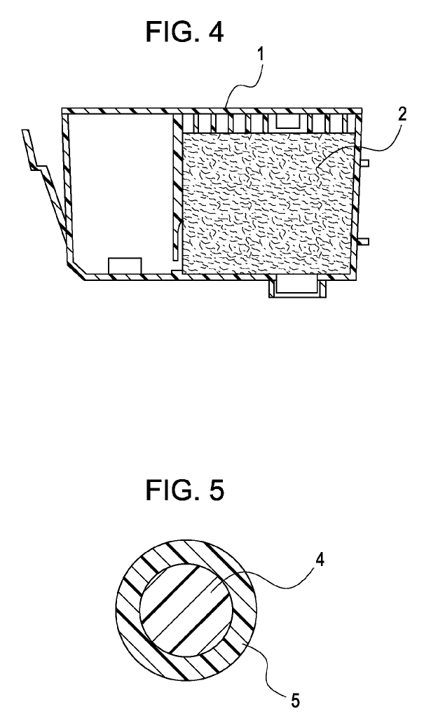

According to a first embodiment of the invention a fibrous absorber 2, as shown for example in FIG. 4, may be made of a relatively inexpensive, lightweight, recyclable olefin resin that is capable of fairly easily forming fibers, and may be made of polypropylene.

The polypropylene mentioned herein may be any one or more of isotactic polypropylene, syndiotactic polypropylene and atactic polypropylene, unless otherwise specified.

As shown in FIG. 5, the fibrous absorber 2 may comprise fiber including a core 4 and a sheath 5 covering the core 4 to define an outermost layer of the fiber, thereby forming a double-layer structure. The core 4 may comprise a resin having a higher melting point than the resin forming the sheath 5. By heating the fiber at a temperature higher than the melting point of the sheath 5 and lower than the melting point of the core 4, portions of the fiber can be fused to produce an absorber 2. That is, the fiber having a double-layer structure including the core and the sheath can become aggregated. The sheath can be melted to fuse the intersections of the fiber loops in the aggregate, and thus a fibrous absorber 2 can be produced. In one version, it may be advantageous that the core 4 and the sheath 5 have a larger difference in melting point, as a smaller difference in melting point may make it difficult to control temperature. For example, the core may be melted and may not maintain its own shape when the fiber is heated to form the absorber.

In the present embodiment, the core 4 may comprise a polypropylene homopolymer, which has a higher melting point and exhibits smaller heat shrinkage than many other polypropylenes. The core 4 may have a melting point of 140° C. or more, and even 160° C. or more. If instead an ethylene-propylene random copolymer that exhibits large heat shrinkage were to be used for the core, it could occur that the resulting absorber could become very hard and have no repulsion because of the shrinkage of the fiber after forming. Such an absorber could form gaps in an ink reservoir and may cause ink to leak. Also, polypropylene can be polymerized in the presence of a metallocene catalyst.

For the sheath 5, a polypropylene that is an ethylene-propylene random copolymer having a low melting point may be used. The sheath 5 has a melting point of less than 140° C., and even 130° C. or less. As the polypropylene having a low melting point, an ethylene-propylene random copolymer polymerized in the presence of a metallocene catalyst may be provided.

The present inventors have found that, according to one aspect of the invention, a suitable polypropylene sheath 5 may have a melting point of less than 140° C. and a melt mass-flow rate (MFR) of 7 g/10 min or more as measured at a temperature of 230° C. and a load of 2.16 kg according to JIS K 7210. If the melt mass-flow rate is less than 7 g/10 min, it can occur that the fibers may not sufficiently fuse with each other, and accordingly the capillary force and the shape of the fibrous absorber may not be maintained. However, if the melt mass-flow rate is excessively high, the material may be melted to move too fast, and accordingly the capillary force and the shape of the fibrous absorber may not be maintained. In addition, the conditions for manufacturing the fibrous absorber of the ink reservoir can become strict. The upper limit of the melt mass-flow rate could not be determined from the experiment in the Example described later because the experiments were conducted using limited materials. However, upper limit for a suitable melt mass-flow rate is believed to be about 40 g/10 min or less. If the melt mass-flow rate is higher than this value, the material may be melted to flow faster and may become difficult to control. Consequently, the capillary force and the shape may not be maintained so as to be suitable as the fibrous absorber for the ink reservoir.

The melt mass-flow rate (MFR) is an index representing the melt viscosity of a resin, and can be measured at a temperature of 230° C. and a load of 2.16 kg according to JIS K 7210 (a Japanese Industrial Standard corresponding to ASTM D1238).

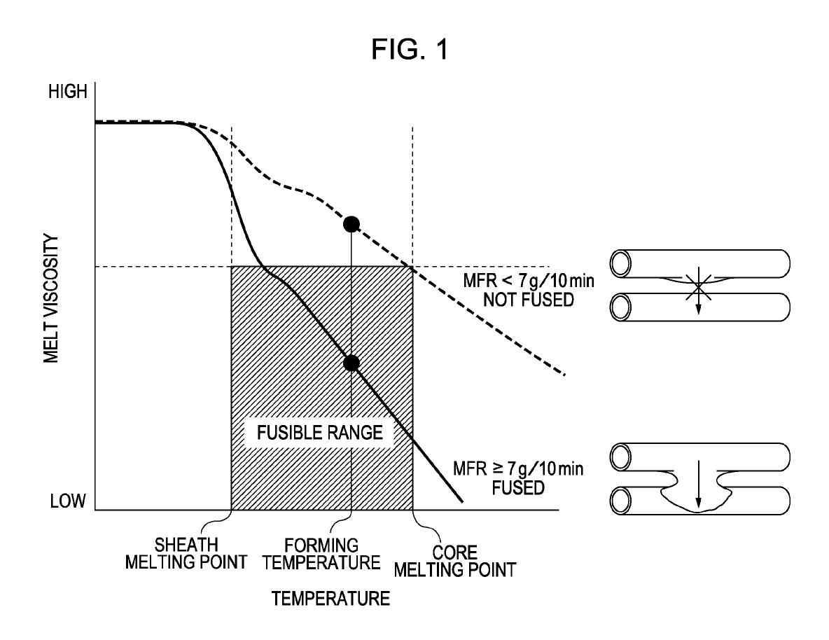

FIG. 1 shows a conceptual representation of the relationship between the forming temperature for fusing the fiber and the melt viscosity of the sheath, illustrating a mechanism for fusing the fiber in detail. The horizontal axis represents temperature, and the vertical axis represents the melt viscosity of the fiber material of the sheath 5. The solid line shows the behavior of a sheath 5 having a higher MFR, and the dashed line shows the behavior of a sheath 5 having a lower MFR. As shown in FIG. 1, sheaths having different MFRs exhibit large differences in melt viscosity at the same forming temperature.

To fuse the fiber, the sheath 5 may be heated to at least partially melt so that the melted sheath 5 flows to nearby portions of the fiber. Accordingly, the forming temperature may be equal to or more than the melting point of the sheath 5. However, if the forming temperature is also higher than the melting point of the core 4, the fiber may not maintain its own shape. Accordingly, a suitable forming temperature may be higher than the melting point of the sheath 5 and lower than the melting point of the core 4.

The inventors have found that, in addition to the forming temperature, the melt viscosity of the sheath 5 is also an important factor for fusing the fiber. A sheath 5 having an excessively high melt viscosity (e.g., dashed line in FIG. 1) does not adequately flow to move to nearby portions of the fiber even if the sheath 5 is melted. On the other hand, when a sheath 5 having a sufficiently low melt viscosity (e.g., solid line in FIG. 1) is melted, the sheath 5 flows to move to nearby portions of the fiber, and thus portions of the fiber can be fused to each other. Accordingly, the diagonally shaded area in FIG. 1 represents such a fusible range. When the upper limit of the forming temperature is equal to the melting point of the core 4, the lower limit is equal to the melting point of the sheath 5, and the sheath 5 has an MFR of 7 g/10 min or more, a melt viscosity suitable for fusion may be provided.

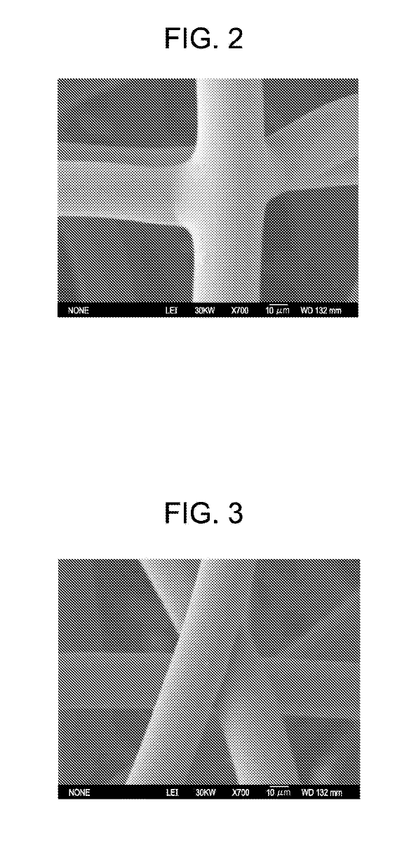

FIGS. 2 and 3 show actual fused and unfused states of a fiber. These figures are photographs of fibers observed by SEM. FIG. 2 shows a state of a fused fiber, and FIG. 3 shows a state of an unfused fiber. A sheath 5 having an MFR of 7 g/10 min or more can fuse and result in a fibrous absorber 2 for an ink reservoir, having a sufficient strength and capillary force. The higher the MFR, the more the fusion occurs. In contrast, when the MFR is less than 7 g/10 min, fusion may hardly occur, and the result may be the fiber state as shown in FIG. 3. A fibrous absorber 2 whose fiber is not fused exhibits a low strength and an insufficient capillary force. Consequently, the resulting ink reservoir may not adequately function.

Although the ratio of the sheath 5 to the core 4 is not particularly limited, it is may be about 1:1 on a weight basis. In one version, the sheath 5 does not contain a neutralizer because the neutralizer may leach into the ink. The residue from the metallocene catalyst may hardly cause any disadvantage, and accordingly a neutralizer may not be required. Thus, in order to produce a low-melting-point polypropylene, and in order to suppress the leaching of neutralizer, the sheath 5 may be made of a polypropylene polymerized in the presence of a metallocene catalyst. On the other hand, the core 4 may also optionally contain a neutralizer, such as a hydrotalcite compound, because the sheath 5 may be capable of restraining the leaching of the neutralizer from the core 4.

In one version, the fiber having the above-described core/sheath structure may be formed in a floc. The intertwined fiber of the floc can be disentangled and processed into web sheets with a carding machine. The web sheets may be bundled together and passed through a heating roller to fuse the fibers in the bundle with each other. The fused fibrous absorber 2 can be cut to a predetermined length in view of the capillary force and other factors, such as after being put in a case of the ink reservoir. The fused fibrous absorber 2 may be capable of maintaining a shape suitable for generating a capillary force even after absorbing ink. Also, even if an external force is applied to the ink reservoir, such as vibration or drop impact during transfer or storage, or environmental changes occur, such as changes in pressure or temperature, the fibrous absorber can be secured in the ink reservoir.

The ink retention of the fibrous absorber 2 depends on the number of crimps, the fineness and the density of the fiber of the fibrous absorber 2. The fibrous absorber 2 for the ink reservoir has a capillary force (such as 0 to 150 mmAq, and even 30 to 100 mmAq) such that the ink is delivered to the ink jet head and is retained in the reservoir.

To provide a sufficient capillary force, in one version the fiber of the fibrous absorber 2 may have a crimp rate of 5 to 25 and a fineness of 0.7 to 18 deniers. The number of crimps (or crimp rate) is defined in JIS L 1015 as the number of crimps (fiber crinkles) for a length of 25 mm, and is obtained by counting the total peaks and troughs and dividing the number by two. In an ink absorber formed by aggregating fiber, as the number of crimps is increased, the number of intersections of the fiber loops is increased. Accordingly, portions of the fiber can become difficult to displace. Consequently, very small stable spaces can be formed in the ink reservoir. Accordingly, the ink retention resulting from capillary action is increased as the number of crimps is increased. On the other hand, the lower the ink retention, the better the efficiency in use of the ink. Hence, as the ink retention is reduced, more of the ink retained in the ink absorber is drawn to deliver, thus increasing the efficiency in use of the ink. In order to obtain a sufficient ink retention and efficiency in use of the ink, the crimp rate can be 5 to 25, and even 10 to 20.

The fineness of the fiber can be 0.7 deniers (about 10 μm in diameter) to 18 deniers (about 50 μm in diameter). When the outer diameter of the fiber is increased with the fiber-occupied volume remaining constant, the space in the aggregate of the fiber becomes larger to reduce the ink retention produced by negative pressure. In contrast, when the outer diameter of the fiber is reduced, the space in the aggregate of the fiber becomes smaller to increase the ink retention. It is considered that a fibrous absorber 2 having a density of 0.02 to 0.06 (g/cm³) may be suitable to retain ink.

According to one aspect of the invention, the polypropylenes (e.g., the homopolymer and random copolymer) used in the present embodiment may be produced (i.e., polymerized) in the presence of a metallocene catalyst. A metallocene catalyst is a mixture of aluminoxane, a non-coordinating ionic compound or the like, and a compound having a structure in which a transition metal, such as titanium, iron, zirconium or hafnium, is caught in a compound having a cyclopentadienyl skeleton. Exemplary metallocene compounds are disclosed in, for example, Japanese Patent No. 4002794, and include but are not limited to bis(cyclopentadienyl)zirconium dichloride, bis(indenyl)zirconium dichloride, bis(fluorenyl)zirconium dichloride, bis(azulenyl)zirconium dichloride, bis(4,5,6,7-tetrahydroindenyl)zirconium dichloride, (cyclopentadienyl)(3,4-dimethylcyclopentadienyl)zirconium dichloride, methylenebis(cyclopentadienyl)zirconium dichloride, methylene(cyclopentadienyl)(3,4-dimethylcyclopentadienyl)zirconium dichloride, isopropylidene(cyclopentadienyl)(3,4-dimethylcyclopentadienyl)zirconium dichloride, ethylene(cyclopentadienyl)(3,5-dimethylpentadienyl)zirconium dichloride, methylenebis(indenyl)zirconium dichloride, ethylenebis(2-methylindenyl)zirconium dichloride, ethylene-1,2-bis(4-phenylindenyl)zirconium dichloride, ethylene(cyclopentadienyl)(fluorenyl)zirconium dichloride, dimethylsilylene(cyclopentadienyl)(tetramethylcyclopentadien yl)zirconium dichloride, dimethylsilylenebis(indenyl)zirconium dichloride, dimethylsilylenebis(4,5,6,7-tetrahydroindenyl)zirconium dichloride, dimethylsilylene(cyclopentadienyl)(fluorenyl)zirconium dichloride, dimethylsilylene(cyclopentadienyl)(octahydorofluorenyl)zirco nium dichloride, methylphenylsilylenebis[1-(2-methyl-4,5-benzo(indenyl))zirconium dichloride, dimethylsilylenebis[1-(2-methyl-4,5-benzoindenyl)]zirconium dichloride, dimethylsilylenebis[1-(2-methyl-4H-azulenyl)]zirconium dichloride, dimethylsilylenebis[1-(2-methyl-4-(4-chlorophenyl)-4H-azulenyl)]zirconium dichloride, dimethylsilylenebis[1-(2-ethyl-4-(4-chlorophenyl)-4H-azulenyl)]zirconium dichloride, dimethylsilylenebis[1-(2-ethyl-4-naphthyl-4H-azulenyl)]zirconium dichloride, diphenylsilylenebis[1-(2-methyl-4-(4-chlorophenyl)-4H-azulenyl)]zirconium dichloride, dimethylsilylenebis[1-(2-methyl-4-(phenylindenyl))]zirconium dichloride, dimethylsilylenebis[1-(2-ethyl-4-(phenylindenyl))]zirconium dichloride, dimethylsilylenebis[1-(2-ethyl-4-naphthyl-4H-azulenyl)]zirconium dichloride, dimethylgermylenebis(indenyl)zirconium dichloride, and dimethylgermylene(cyclopentadienyl)(fluorenyl)zirconium dichloride. Exemplary aluminoxanes include but are not limited to methyl aluminoxane, methyl isobutyl aluminoxane, and isobutyl aluminoxane.

The structure of the fibrous absorber according to the embodiment will now be further described in detail with reference to Examples. The fibrous absorber can be held in a polypropylene case to form an ink reservoir. The ink reservoir can retain ink, and the ink reservoir containing ink may be mounted in a printer and then used. The invention is furthermore not limited to the following Examples, and embodiments other than those specifically described herein may also be provided.

### EXAMPLE 1

For the core 4, a polypropylene homopolymer (melting point: 165° C.; MFR (hereinafter representing the melt mass-flow rate measured according to JIS K 7210): 23 g/10 min) polymerized in the presence of a Ziegler-Natta catalyst was used, and 500 ppm of a hydrotalcite compound (Mg_{4.3}Al₂(OH)_{12.6}CO₃.mH₂O) was added as a neutralizer. For the sheath 5, an ethylene-propylene random copolymer (melting point: 125° C.; MFR: 25 g/10 min) polymerized in the presence of a metallocene catalyst was used. No neutralizer was used.

The core and the sheath were formed in a ratio of 1:1 by extrusion. The fiber formed in a floc was disentangled and formed into web sheets with a carding machine. The web sheets were bundled together, and only the sheaths were melted through a heating roller of 140° C. so that the fibers were fused to form a fibrous absorber 2.

### EXAMPLE 2

A fibrous absorber 2 was formed in the same manner as in Example 1, except that the forming temperature of the fibrous absorber 2 was 135° C. in the heating roller.

### EXAMPLE 3

For the core 4, a polypropylene homopolymer (melting point: 160° C.; MFR: 23 g/10 min) polymerized in the presence of a metallocene catalyst was used. No neutralizer was used. The other conditions were the same as in Example 1.

### EXAMPLE 4

For the sheath 5, an ethylene-propylene random copolymer (melting point: 125° C.; MFR: 7 g/10 min) polymerized in the presence of a metallocene catalyst was used. No neutralizer was used. The other conditions were the same as in Example 1.

### COMPARATIVE EXAMPLE 1

In Comparative Example 1, a well-known fibrous absorber 2 was prepared which is formed of fiber including a polypropylene core 4 and a polyethylene sheath 5. In Comparative Example 1, a polyethylene homopolymer (melting point: 130° C.; MFR: 12.5 g/10 min) polymerized in the presence of a Ziegler-Natta catalyst) was used for the sheath 5, and 500 ppm of a hydrotalcite compound (Mg_{4.3}Al₂(OH)_{12.6}CO₃.mH₂O) was added as a neutralizer. The other conditions were the same as in Example 1.

### COMPARATIVE EXAMPLE 2

An ethylene-propylene random copolymer (melting point: 125° C.; MFR: 5 g/10 min) polymerized in the presence of a metallocene catalyst was used for the sheath 5. No neutralizer was used. The other conditions were the same as in Example 1.

### COMPARATIVE EXAMPLE 3

An ethylene-propylene random copolymer (melting point: 145° C.; MFR: 30 g/10 min) polymerized in the presence of a metallocene catalyst was used for the core 4. No neutralizer was used.

An ethylene-propylene random copolymer (melting point: 125° C.; MF: 7 g/10 min) polymerized in the presence of a metallocene catalyst was used for the sheath 5. No neutralizer was used. The other conditions were the same as in Example 1.

### Evaluation

The fused state and the shape of the fibrous absorbers 2 prepared in Examples 1 to 4 and Comparative Examples 1 to 3 were observed, and the results are shown in Table 1.

### Fused State

The prepared fibrous absorber 2 was cut out into a piece of 5 mm by 5 mm. After platinum vapor deposition, it was observed by scanning electron microscopy (SEM) whether or not the fibers were fused. A fused sample was observed as shown in FIG. 2, and unfused sample was observed as shown in FIG. 3. The results are shown in Table 1. In Examples 1 to 4, fusion was observed at 10 to several tens of points in the area of 5 mm×5 mm, and thus the fusion equivalent to that in Comparative Example 1 was observed. In Example 4, the fusion was in substantially the same state as in Examples 1 to 3, but the number of fused points was slightly smaller. There was no difference in fusion state between Examples 1 and 2, in which the fibrous absorbers 2 were formed at different temperatures. The fibrous absorbers 2 of Examples 1 to 4 were placed in respective ink reservoirs, and retained ink. The resulting ink reservoirs did not produce problems.

On the other hand, the fibrous absorber 2 of Comparative Example 2 was not fused, and when it was placed in the ink reservoir and retained ink, the fibrous absorber 2 shrunk and did not maintain a predetermined shape and capillary force for the fibrous absorber 2 of the ink reservoir.

### Shape

The fibrous absorbers 2 of Examples 1 to 4 maintained the predetermined shape for use in the ink reservoir. On the other hand, the fibrous absorber 2 of Comparative Example 3 became seriously shrunken after being formed, and thus the predetermined shape for use in the ink reservoir was not formed.

Without being limited to any theory, this may be because the core 4 was made of random polypropylene, and, after forming, the stress relaxation of the fiber caused the fiber to shrink. The results of Comparative Example 3 suggest that a less shrinkable homopolymer may be suitable as the material of the core 4.

### Leaching of Al

The resulting fibrous absorber 2 was immersed in a test ink and heated to 100° C. for 10 hours in a PCT (pressure cooker tester). After cooling to room temperature, the amount of Al leached into the test ink was measured by ICP. The amount of leached Al was compared among the fibrous absorbers of Examples 1 and comparative Examples 1 to 3, which were formed under the same conditions. The results are shown in the Table 1. In the Table 1, PP represents a polypropylene resin, and PE represents a polyethylene resin.

The fibrous absorbers of Examples 1, 2 and 4, whose sheaths 5 did not contain a neutralizer, leached Al much less than the fibrous absorber of Comparative Example 1 whose sheath 5 contained a neutralizer. Furthermore, Al leached from the fibrous absorber of Example 3 was not detected. This suggests that by use of a polypropylene polymerized in the presence of a metallocene catalyst for the sheath 5, the leaching of Al, which may cause a problem in printing, can be reduced.

TABLE 1

| | | | | | | | | | | | | Amount | |
|---|---|---|---|---|---|---|---|---|---|---|---|---|---|
| | | | | | | | | Forming | Form- | | | of | |
| | | | | | | Melting | MFR | Tempe- | ing | | | leached | |
| | | | Polymer | | Use of | point | (g/10 | rature | time | | | Al | Material |
| | | Resin | structure | Catalyst | Neutralizer | (° C.) | min) | (° C.) | (min) | Fusion | Shape | (ppb) | recycle |
| Example 1 | Core | PP | Homo | Ziegler-Natta | Yes | 165 | 23 | 140 | 25 | Excellent | Good | <20 | Good |
| | Sheath | PP | Random | Metallocene | No | 125 | 25 | | | | | | |
| Example 2 | Core | PP | Homo | Ziegler-Natta | Yes | 165 | 23 | 135 | 25 | Excellent | Good | <20 | Good |
| | Sheath | PP | Random | Metallocene | No | 125 | 25 | | | | | | |
| Example 3 | Core | PP | Homo | Metallocene | No | 160 | 23 | 140 | 25 | Excellent | Good | N.D. | Good |
| | Sheath | PP | Random | Metallocene | No | 125 | 25 | | | | | | |
| Example 4 | Core | PP | Homo | Ziegler-Natta | Yes | 165 | 23 | 140 | 25 | Good | Good | <20 | Good |
| | Sheath | PP | Random | Metallocene | No | 125 | 7 | | | | | | |
| Comparative | Core | PP | Homo | Ziegler-Natta | Yes | 165 | 23 | 140 | 25 | Excellent | Good | 50 | Bad |
| Example 1 | Sheath | PE | Homo | Ziegler-Natta | Yes | 130 | 12.5 | | | | | | |
| Comparative | Core | PP | Homo | Ziegler-Natta | Yes | 165 | 23 | 140 | 25 | Bad | Good | <20 | — |
| Example 2 | Sheath | PP | Random | Metallocene | No | 125 | 5 | | | | | | |
| Comparative | Core | PP | Random | Metallocene | No | 145 | 30 | 140 | 25 | Good | Bad | N.D. | — |
| Example 3 | Sheath | PP | Random | Metallocene | No | 125 | 7 | | | | (shrunk) | | |

### Material Recycle

The possibility of recycling the fibrous absorbers prepared in Examples 1 to 4 and Comparative Example 1, to obtain a recycled material, are shown in the Table 1. The fibrous absorber was cut into pieces of a predetermined size. After being washed and dried, the pieces of the fibrous absorber were formed into pellets. The pellets were recycled into a case of an ink reservoir by injection molding. As a result, the case recycled from the fibrous absorber of Comparative Example 1 exhibited a considerably degraded heat resistance and strength, and was unsuitable for the ink reservoir. Without being limited to any particular theory, this may be because hybrids of PP and PE have a lower heat resistance and strength than simple PP, and because phase separation between PP and PE may affect such properties. On the other hand, the cases recycled from the fibrous absorbers of Examples 1 to 4 exhibited relatively favorable heat resistances and strengths, and were suitable for the ink reservoir.

It was also examined by IR spectroscopy whether or not the cases were formed of the materials used in the Examples. While the materials derived from Examples 1 to 4 did not show the typical PE peak at a wavelength of 719 cm⁻¹, the material from Comparative Example 1 showed that peak.

These results indicate that waste ink reservoirs can be recycled into, for example, a polypropylene material for the case of an ink reservoir, by being collected and applying a recycling process to the collected ink reservoirs having the fibrous absorber contained therein.

The examples also show that an ink reservoir can be provided containing a recyclable fibrous absorber that is made of a fiber material produced in a process limiting the use of neutralizer, including a core and a sheath made of materials of the same type.

The examples further show that by forming the core of a high-melting point polypropylene homopolymer, and forming the sheath of a low-melting point ethylene-propylene random copolymer, the double-layer core/sheath structure can be formed of only polypropylene. In particular, an ethylene-propylene random copolymer polymerized in the presence of a metallocene catalyst can be provided have the same melting point as a polyethylene. Furthermore, the metallocene catalyst contains scarcely any metal-corrosive chlorine, and does not require the use of neutralizer for producing a fiber material.

The examples further demonstrate that the present inventors have found that a sheath having not only a specific melting point, but also a specific melt mass-flow rate specified in JIS K 7210 can be favorably fused at the intersections of fiber loops to enhance the strength of the resulting fibrous absorber.

Thus, an ink reservoir prepared according to the examples is recyclable and environmentally friendly. In addition, the ink reservoir has a reduced likelihood of causing failure in printing caused by a neutralizer.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-135686 filed May 23, 2008, which is hereby incorporated by reference herein in its entirety.

What is claimed is:

1. An ink reservoir capable of retaining ink, comprising:
a case comprising a polypropylene; and
a fibrous absorber contained in the case, the fibrous absorber comprising an aggregate of fiber having a double-layer structure including a core and a sheath, the sheath being fused at intersections of fiber loops,
wherein the core comprises a polypropylene homopolymer having a melting point of 140° C. or more, and the sheath comprises an ethylene-propylene random copolymer having a melting point of less than 140° C. and a melt mass-flow rate of 7 g/10 min or more as measured at 230° C. and a load of 2.16 kg according to JIS K 7210.

2. The ink reservoir according to claim 1, wherein the ethylene-propylene random copolymer of the sheath is polymerized in the presence of a metallocene catalyst.

3. The ink reservoir according to claim 1, wherein the fiber of the fibrous absorber has a fineness of 0.7 to 18 deniers and a crimp rate of 5 to 25, and the fibrous absorber has a capillary force of 150 mmAq or less.

4. The ink reservoir according to claim 1, wherein the ink reservoir can be recycled into a polypropylene material by being melted with the fibrous absorber contained therein.
